(19) United States
(12) Patent Application Publication
(10) Pub. No.: US 2025/0225136 A1
(43) Pub. Date: Jul. 10, 2025

(54) DATA SELECTION AND STORAGE ON THE EDGE FOR EFFICIENT EDGE LEARNING

(71) Applicant: TECHNOLOGY INNOVATION INSTITUTE - SOLE PROPRIETORSHIP LLC, Masdar City, Abu Dhabi (AE)

(72) Inventors: George ARVANITAKIS, Abu Dhabi (AE); Hakim HACID, Dubai (AE)

(73) Assignee: TECHNOLOGY INNOVATION INSTITUTE - SOLE PROPRIETORSHIP LLC, Masdar City, Abu Dhabi (AE)

(21) Appl. No.: 18/690,125

(22) PCT Filed: Mar. 17, 2023
(86) PCT No.: PCT/GR2023/000006

§ 371 Date: Mar. 7, 2024

(51) Int. Cl. G06F 16/248

(52) U.S. Cl. CPC G06F 16/248

(57) ABSTRACT

The present embodiments relate to systems, methods, and computer-readable media for selecting data to be stored at an edge device. More particularly, the present embodiments relate to an optimized data selection process for increased targeting of data observations that can be stored on the edge device for maximized edge learning quality. The selected data for storage at the edge can represent each class of a specified problem, maximizes the performance of the selected learning model, and can incrementally maintain a support set for further learning. The present embodiments can allow for robust learning on the edge with improved latency and improved privacy.

### TECHNICAL FIELD

This disclosure relates to systems, methods, and computer-readable media for selecting data to be stored at an edge device. More particularly, the present embodiments relate to an optimized data selection process for increased targeting of data observations that can be stored on the edge device for maximized edge learning quality.

### BACKGROUND

Various computing networks that implement machine learning, deep learning, and/or artificial intelligence (AI) can include a series of interconnected computing devices (e.g., cloud computers) and a number of edge devices capable of performing a series of processing tasks. The edge devices in such computing networks can obtain data and provide the data to the cloud computers for processing.

In some cases, the edge devices can perform processing as part of a machine learning or deep learning system. For example, an edge device can implement processing as part of a deep neural network (DNN) for any of a variety of use cases, such as image recognition, portrait mode photography, text prediction, user profiling, de-noising, camera enhancement, activity recognition, etc. Further, edge devices can perform processing as part of an unmanned aerial vehicle (UAV) network, a vehicle network, a wearable device, medical sensors, etc.

AI techniques can be implemented on the edge of a computing network. This can include an edge device being configured as an autonomous AI entity. Configuring an edge device as an autonomous AI entity can improve latency and privacy, as data may not need to be transmitted between the edge device and a remote cloud computing infrastructure.

### SUMMARY

The present embodiments relate to systems, methods, and computer-readable media for selecting data to be stored at an edge device. More particularly, the present embodiments relate to an optimized data selection process for increased targeting of data observations that can be stored on the edge device for maximized edge learning quality. The selected data for storage at the edge can represent each class of a specified problem, maximizes the performance of the selected learning model, and can incrementally maintain a support set for further learning. The present embodiments can allow for robust learning on the edge with improved latency and improved privacy.

A first example embodiment is a method for selecting data to be stored at an edge device. The method can include training a machine learning model at the edge device using learning data obtained at the edge device. Each of the learning data can include a data type that is part of a feature space. The edge device can be a computing device part of a cloud computing infrastructure configured to implement the machine learning model at the edge device. The learning data can include input data obtained from one or more sensors connected to the edge device.

As an illustrative example, the machine learning model can include a model configured to determine whether a physical activity is being performed. The edge device (e.g., a mobile device) can obtain various data types (e.g., heart rate information, oxygen sensors, elevation information). The machine learning model can be trained using learning data either obtained at the edge device or from data transmitted to the edge device from the cloud computing infrastructure.

The method can also include processing the machine learning model to derive a scoring vector for the machine learning model. The scoring vector can include a series of elements specifying a relevance of each data type for training the machine learning model. For example, model information for the machine learning model can be processed to identify data types being used in the model.

Each of the elements in the scoring vector can provide a value ranking the relevance of each data type for the machine learning model using data specific to the machine learning model. For example, for a model detecting whether a physical activity being performed, a first data type (e.g., a heart rate) can have a higher ranking in the scoring vector than a less relevant data type (e.g., climate sensor data) obtained at the edge device. The scoring vector can include values specifying the relative importance or relevance of each data type in performing the model. The scoring vector is derived using a feature importance model.

The method can also include deriving a similarity matrix from the learning data and the scoring vector. The similarity matrix can include a plurality of cells indicative of a similarity between data of different data types and the series of elements in the scoring vector.

The plurality of cells in the similarity matrix can include a value specifying a commonality between data instances in the learning data. For example, instances of learning data of varying data types can be processed to identify a similarity between the instances of learning data. The similarity matrix can be used to identify a wide range of relevant data to be included in the selected data to be stored at the edge device to maximize efficiency and accuracy in subsequent training of the model. The similarity matrix can be derived using a gaussian kernel function.

The method can also include generating a list of selected data of the learning data to be stored at the edge device based at least on the similarity matrix. The list can specify instances of learning data to be stored that maximizes edge device constraints and machine learning training.

In some instances, the list of selected data can be generated based on at least one constraint to the edge device, the at least one constraint comprising any of: a specified data storage capacity of the edge device, a specified processing power of the edge device, a specified bandwidth of the edge device, and a specified power consumption of the edge device. The list of selected data can be generated using a maximize variance model.

In some instances, the embodiments can include further training the machine learning model using data stored at the edge device according to the list of selected data.

In another example embodiment, a system is provided. The system can include one or more cloud computing nodes, one or more sensors, and an edge device in electrical communication with the one or more cloud computing nodes and the one or more sensors.

The edge device can be operative to obtain a machine learning model from the one or more cloud computing nodes. The edge device can also obtain learning data from the one or more sensors.

The edge device can also train the machine learning model at the edge device using learning data obtained at the edge device. The edge device can also process the machine learning model to derive a scoring vector for the machine learning model. In some instances, the scoring vector comprising a series of elements specifying a relevance of each data type for training the machine learning model. Further, each of the similarity of elements in the scoring vector can provide a value ranking the relevance of each data type for the machine learning model using data specific to the machine learning model. The scoring vector can be derived using a feature importance model.

The edge device can also derive a similarity matrix from the learning data and the scoring vector. The similarity matrix can include a plurality of cells indicative of a similarity between data of different data types and the series of elements in the scoring vector.

In some instances, the plurality of cells in the similarity matrix can include a value specifying a commonality between data instances in the learning data. In some instances, the list of selected data is generated based on at least one constraint to the edge device, the at least one constraint comprising any of: a specified data storage capacity of the edge device, a specified processing power of the edge device, a specified bandwidth of the edge device, and a specified power consumption of the edge device

The edge device can also generate a list of selected data of the learning data to be stored at the edge device based at least on the similarity matrix.

In some instances, the embodiments can also include further training the machine learning model using data stored at the edge device according to the list of selected data.

In another example embodiment, a computer-readable storage medium is provided. The computer-readable storage medium can contain program instructions for a method being executed by an application, the application comprising code for one or more components that are called by the application during runtime, wherein execution of the program instructions by one or more processors of a computer system causes the one or more processors to perform steps.

The steps can include training a machine learning model at an edge device using learning data obtained at the edge device. Each of the learning data can include a data type that is part of a feature space.

The steps can also include processing the machine learning model to derive a scoring vector for the machine learning model. The scoring vector can include a series of elements specifying a relevance of each data type for training the machine learning model. In some instances, each of the elements in the scoring vector provides a value ranking the relevance of each data type for the machine learning model using data specific to the machine learning model.

The steps can also include deriving a similarity matrix from the learning data and the scoring vector. The similarity matrix can include a plurality of cells indicative of a similarity between data of different data types and the series of elements in the scoring vector. In some instances, the plurality of cells in the similarity matrix can include a value specifying a commonality between data instances in the learning data.

The steps can also include generating a list of selected data of the learning data to be stored at the edge device based at least on the similarity matrix. In some instances, the list of selected data is generated based on at least one constraint to the edge device, the at least one constraint comprising any of: a specified data storage capacity of the edge device, a specified processing power of the edge device, a specified bandwidth of the edge device, and a specified power consumption of the edge device.

The steps can also include storing a subset of the learning data according to the list of selected data. The steps can also include further training the machine learning model using the subset of the learning data stored at the edge device.

This Summary is provided to summarize some example embodiments, so as to provide a basic understanding of some aspects of the subject matter described in this document. Accordingly, it will be appreciated that the features described in this Summary are merely examples and should not be construed to narrow the scope or spirit of the subject matter described herein in any way. Unless otherwise stated, features described in the context of one example may be combined or used with features described in the context of one or more other examples. Other features, aspects, and advantages of the subject matter described herein will become apparent from the following Detailed Description, Figures, and Claims.

### BRIEF DESCRIPTION OF THE DRAWINGS

The above and other aspects of the disclosure, its nature, and various features will become more apparent upon consideration of the following detailed description, taken in conjunction with the accompanying drawings, in which like reference characters may refer to like parts throughout, and in which:

FIG. 1 is an illustration of an example computing system that includes one or more edge computing devices according to an embodiment.

FIG. 2 is an illustration of an example edge device according to an embodiment.

FIG. 3 is an example flow process for selecting data to be stored at an edge device according to an embodiment.

FIG. 4 illustrates a flow process of an example method for selecting data to be stored at an edge device according to an embodiment.

FIG. 5 is a block diagram of a special-purpose computer system according to an embodiment.

### DETAILED DESCRIPTION

Various computing networks that implement machine learning, deep learning, and/or artificial intelligence (AI) can include a series of interconnected computing devices (e.g., cloud computers) and a number of edge devices capable of performing a series of processing tasks. The edge devices in such computing networks can obtain data and provide the data to the cloud computers for processing.

In some cases, the edge devices can perform processing as part of a machine learning or deep learning system. For example, an edge device can implement processing as part of a deep neural network (DNN) for any of a variety of use cases, such as image recognition, portrait mode photography, text prediction, user profiling, de-noising, camera enhancement, activity recognition, etc. Further, edge devices can perform processing as part of an unmanned aerial vehicle (UAV) network, a vehicle network, a wearable device, medical sensors, etc.

Various AI techniques can be implemented on the edge of a computing network. This can include an edge device being configured as an autonomous AI entity. Configuring an edge device as an autonomous AI entity can improve latency and privacy, as data may not need to be transmitted between the edge device and a remote cloud computing infrastructure over a network.

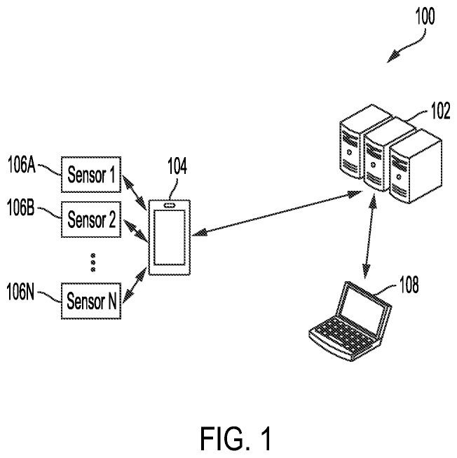

FIG. 1 is an illustration of an example computing system 100 that includes one or more edge devices. As shown in FIG. 1, the system 100 can include a series of interconnected computing devices (or cloud computing infrastructure) 102 and one or more edge devices 104, 108. An edge device 104, 108 can include various electronic devices, such as a mobile phone, computer, chipset in a vehicle, unmanned aerial vehicle (UAV), etc.

The edge device(s) 104, 108 can interact with the series of interconnected computing devices 102 as part of a deep neural network or AI infrastructure as described herein. For example, edge device 104 can include a series of sensors 106A-N configured to obtain data of various types. The obtained data can be processed using one or more models (e.g., a machine learning model) on the edge device 104 to derive insights into the obtained data. As an illustrative example, the machine learning model executing on the edge device can include a physical activity detection model configured to process input data to determine whether a specific activity (e.g., running, rock climbing) is being performed. As described in greater detail below, the edge device (e.g., 104) can store at least some training data to train the machine learning model.

However, an edge device configured to perform AI processing can have various constraints. For example, there can include a processing power constraint (e.g., the total processing power of the edge device can be limited), a storage constraint (e.g., total storage capacity of the edge device can be limited) a connectivity constraint (e.g., total bandwidth of the edge device can be limited), and/or an energy constraint (e.g., an energy usage capacity of the edge device can be limited). Such constraints can limit the total resources capable of being used on an edge device in performing various AI processing tasks.

Edge devices configured to perform AI processing may include instructions for machine learning on the edge device. However, such machine learning may need some data (e.g., training data) stored on the edge device to implement the machine learning. Therefore, there exists a need for data selection and storage on the edge for efficient edge learning. Also, there also exists a need for selecting the best observations to be stored on the edge device that can support a high-quality (incremental) learning on the edge device.

The present embodiments relate to an optimized data selection process for increased targeting of data observations that can be stored on the edge device for maximized edge learning quality. The selected data for storage at the edge can represent each class of a specified problem, maximizes the performance of the selected learning model, and can incrementally maintain a support set for further learning. The present embodiments can allow for robust learning on the edge with improved latency and improved privacy.

The present embodiments can implement systems and methods that can couple the data selection process with the machine learning algorithm and edge constraints for optimized incremental learning on the edge. More particularly, an edge device can be configured to implement a ranking-selection-optimization (RSO) selection block that can include multiple interconnected modules (or subsystems).

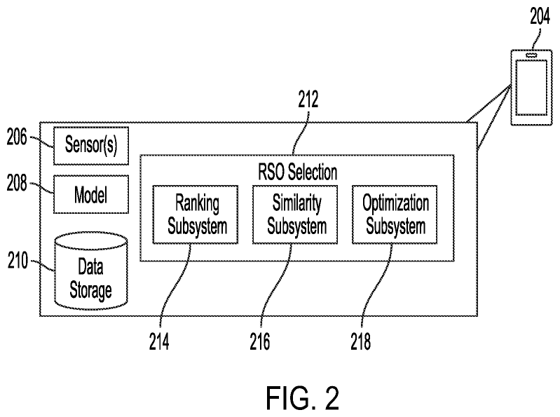

FIG. 2 is an illustration of an example edge device 204. As noted above, an edge device 204 can include a device such as a mobile device, computer, wearable device, etc. Further, the edge device 204 can be part of a system, such as a UAV, vehicle, medical system, internet of things (IoT) network, etc.

As shown in FIG. 2, the edge device 204 can include one or more sensors 206. Sensors 206 can obtain various data types to be processed as described herein. Example sensors 206 can include biometric data sensors (e.g., heartbeat, oxygen level), positioning sensors (e.g., acceleration, moving speed, elevation change), climate sensors, etc. The sensor data can be used as learning data to train the data and can be selected to be stored at the edge device 204 (e.g., at data storage 210) as described herein. The data storage 210 can store information relating to the model, the learning data, the selected subset of data to be stored at the edge device, etc.

The edge device 204 can also include a model 208. The model 208 can include a machine learning model capable of being performed at the edge device 204. An example model 208 can include a model to detect a physical activity being performed.

The edge device 204 can also include a ranking-similarity-optimization (RSO) selection subsystem 212. The RSO selection subsystem 212 can input the model 208 and learning data (e.g., data obtained from sensors 206 and/or from a cloud computing device) for processing as described herein.

The RSO selection subsystem 212 can include a ranking subsystem 214. The ranking subsystem 214 can input the model 208 and any associated model information to generate a scoring vector for the model 208. The scoring vector can specify a relevance of each data type in training the model. The ranking subsystem 214 can be implemented via a feature importance (e.g., SHAP feature importance) model.

The RSO selection subsystem 212 can also include a similarity subsystem 216. The similarity subsystem 216 can input the scoring vector and the learning data to derive a similarity matrix for the model. The similarity subsystem 216 can be implemented via a gaussian kernel model.

The RSO selection subsystem 212 can also include an optimization subsystem 218. The optimization subsystem 218 can process the similarity subsystem 216, the model information, a optimization parameters, and/or edge device constraints. The output can include a list of learning data to be stored at the edge device for future training/learning of the model 208. The optimization subsystem 218 can be implemented via a maximize variance model.

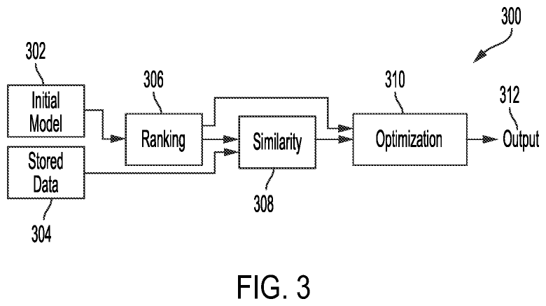

FIG. 3 is an example flow process 300 for selecting data to be stored at an edge device. As shown in FIG. 3, an initial model 302 can be fed into a ranking subsystem 306. The ranking subsystem 306 can process stored data to determine which dimensions of the feature space are informative for the task in hand. Further, an output from the ranking subsystem 306 and stored data 304 can feed into a similarity subsystem 308. The output from the similarity subsystem 308 and the output from the ranking subsystem 306 can be fed into an optimization subsystem 310 to generate an output 312.

As an illustrative example, a model can be configured to process input data to determine whether a particular activity (e.g., running) is being performed. In this example, the edge device can obtain data of various types. Example data types can include acceleration data, speed data, a heart rate of the user, and climate data. In this example, various information types can have a varying relevance to the model. For instance, the data type relating to speed data can have a higher relevance to the model than climate data, which can be less relevant to the model.

The ranking subsystem 306 can use the initial model (e.g., an initially trained model 302) as an input. The initially trained model 302 can include various types (or dimensions) of training data as part of a feature space and other information relating to the model.

The ranking subsystem 306 can process the model 302 and information relating to the model to determine a relevance of each data type. For instance, the processes, algorithms, and/or functions included in the model 302 can be processed to determine data types that are used in the model 302. The relevance of each data type used in the model can be determined based on an amount of instances that a data type is input into the model and/or a weight a data type is given in functions for the model.

The ranking subsystem can further process the initial model to derive a scoring vector that includes a scoring metric for each dimension in the feature space. Each instance in the scoring vector can represent a data type of the input data in the model. The scoring metric can include one or more values specifying a derived relevance of each data type for use in the trained ML model. For example, a scoring metric can be increased based on a relevance of the data type to the model. In the above example, for a model determining whether a user is running, a data type providing information relating to an acceleration of the edge device can have a higher scoring metric than another less relevant metric (e.g., an elevation of the device). The scoring vector can be represented by:

$$R ( F ( \cdot ) ) = {r}^{k} , I$$

The ranking function (R) of the initial model (F) can be processed to derive the scoring vector r^{k} with the model information (I). The output of the ranking subsystem 306 can include the scoring vector.

The similarity subsystem 308 can obtain the scoring vector and the stored data 304 to derive a relationship among the available data. The similarity subsystem 308 can input an initial dataset X^{N,k} (e.g., data 304) and feature scoring vector r^{k}. The similarity subsystem 308 can output a similarity matrix that indicates the common information among the initial data-set. The similarity function can be represented as:

S(X^{k},r^{k})=M

The similarity function(S) of the initial dataset (X^{k}) and the feature scoring vector r^{k}) can output the similarity matrix (M). The similarity matrix M can define cells with information and a commonality between the initial data. For example, the similarity matrix can define a similarity between data specifying a detected speed and a detected heart rate of the user (which can be relevant in determining that the physical activity (running) is being performed). Each (I,j) cell of the matrix can represent the similarity between the i-th observation and the j-th information of the dataset. The information can be captured using various distance metrics and Kernels. Additionally, the distance in each dimension can be scaled according to the importance of this dimension for the model. Each cell in the similarity matrix can include a value specifying a similarity between data types in the stored data. The similarity matrix can be used to select data that is unique across the relevant data types, as the unique data sets can increase efficiency in training the model.

The optimization subsystem 310 can select a small part from the initial data-set that is the most helpful for learning on the edge tasks. The optimization subsystem can input a optimization parameters C, which can include a prioritized constraint, a priority of the selected data, etc.

The optimization parameters can include the optimization constraints of the problem such as, maximum storage capacity of the Edge device, as well as the cost function of the optimization optimization parameters such as maximize the entropy or the variance of the selected set. Edge constraints can include any of a processing power constraint (e.g., the total processing power of the edge device), a storage constraint (e.g., total storage capacity of the edge device) a connectivity constraint (e.g., total bandwidth of the edge device), and/or an energy constraint (e.g., an energy usage capacity of the edge device).

The optimization subsystem can input the optimization parameters C, Similarity Matrix M, Model information I, and Edge constrains Q to generate a list of data to be stored at the device. For example, the list of data to be stored can only store as much data as allotted for the device or the total amount of available storage at the device. The output 312 can include a Selection List L ∈ {0,1}^{N}. The optimization function can be represented as:

$$L = {min}_{L} C ( M \cdot diag ( L ) \vert I , Q )$$

The output 312 can include a list of all selected data. The selected data can specify all data to be stored for future learning of the model.

The data can be the most relevant but also provide ranges of inputs that are used by the model to enhance training. In some instances, redundant instances of the same data are not needed, but rather, the most relevant info and the most robust data can be selected for training.

### Example Method for Selecting Data to be Stored at an Edge Device

As described above, the present embodiments relate to selecting data to be stored at an edge device. The edge device can be part of a cloud computing infrastructure and configured to perform one or more machine learning/artificial intelligence processes at the edge device.

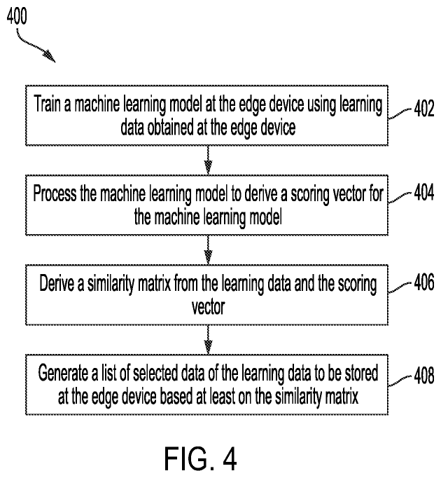

FIG. 4 illustrates a flow process 400 of an example method for selecting data to be stored at an edge device. At 402, the method can include training a machine learning model at the edge device using learning data obtained at the edge device. Each of the learning data can include a data type that is part of a feature space. The edge device can be a computing device part of a cloud computing infrastructure configured to implement the machine learning model at the edge device. The learning data can include input data obtained from one or more sensors connected to the edge device.

As an illustrative example, the machine learning model can include a model configured to determine whether a physical activity is being performed. The edge device (e.g., a mobile device) can obtain various data types (e.g., heart rate information, oxygen sensors, elevation information). The machine learning model can be trained using learning data either obtained at the edge device or from data transmitted to the edge device from the cloud computing infrastructure.

At 404, the method can include processing the machine learning model to derive a scoring vector for the machine learning model. The scoring vector can include a series of elements specifying a relevance of each data type for training the machine learning model. For example, model information for the machine learning model can be processed to identify data types being used in the model.

Each of the elements in the scoring vector can provide a value ranking the relevance of each data type for the machine learning model using data specific to the machine learning model. For example, for a model detecting whether a physical activity being performed, a first data type (e.g., a heart rate) can have a higher ranking in the scoring vector than a less relevant data type (e.g., climate sensor data) obtained at the edge device. The scoring vector can include values specifying the relative importance or relevance of each data type in performing the model. The scoring vector is derived using a feature importance model.

At 406, the method can include deriving a similarity matrix from the learning data and the scoring vector. The similarity matrix can include a plurality of cells indicative of a similarity between data of different data types and the series of elements in the scoring vector.

The plurality of cells in the similarity matrix can include a value specifying a commonality between data instances in the learning data. For example, instances of learning data of varying data types can be processed to identify a similarity between the instances of learning data. The similarity matrix can be used to identify a wide range of relevant data to be included in the selected data to be stored at the edge device to maximize efficiency and accuracy in subsequent training of the model. The similarity matrix can be derived using a gaussian kernel function.

At 408, the method can include generating a list of selected data of the learning data to be stored at the edge device based at least on the similarity matrix. The list can specify instances of learning data to be stored that can maximize use of edge device resources and improve efficiency of machine learning training.

In some instances, the list of selected data is generated based on at least one constraint to the edge device, the at least one constraint comprising any of: a specified data storage capacity of the edge device, a specified processing power of the edge device, a specified bandwidth of the edge device, and a specified power consumption of the edge device. The list of selected data can be generated using a maximize variance model.

In some instances, the method can include further training the machine learning model using data stored at the edge device according to the list of selected data.

In another example embodiment, a system is provided. The system can include one or more cloud computing nodes, one or more sensors, and an edge device in electrical communication with the one or more cloud computing nodes and the one or more sensors.

The edge device can be operative to obtain a machine learning model from the one or more cloud computing nodes. The edge device can also obtain learning data from the one or more sensors.

The edge device can also train the machine learning model at the edge device using learning data obtained at the edge device. The edge device can also process the machine learning model to derive a scoring vector for the machine learning model. In some instances, the scoring vector comprising a series of elements specifying a relevance of each data type for training the machine learning model. Further, each of the similarity of elements in the scoring vector can provide a value ranking the relevance of each data type for the machine learning model using data specific to the machine learning model. The scoring vector can be derived using a feature importance model.

The edge device can also derive a similarity matrix from the learning data and the scoring vector. The similarity matrix can include a plurality of cells indicative of a similarity between data of different data types and the series of elements in the scoring vector.

In some instances, the plurality of cells in the similarity matrix can include a value specifying a commonality between data instances in the learning data. In some instances, the list of selected data is generated based on at least one constraint to the edge device, the at least one constraint comprising any of: a specified data storage capacity of the edge device, a specified processing power of the edge device, a specified bandwidth of the edge device, and a specified power consumption of the edge device

The edge device can also generate a list of selected data of the learning data to be stored at the edge device based at least on the similarity matrix.

In some instances, the edge device is further operative to further train the machine learning model using data stored at the edge device according to the list of selected data.

In another example embodiment, a computer-readable storage medium is provided. The computer-readable storage medium can contain program instructions for a method being executed by an application, the application comprising code for one or more components that are called by the application during runtime, wherein execution of the program instructions by one or more processors of a computer system causes the one or more processors to perform steps.

The steps can include training a machine learning model at an edge device using learning data obtained at the edge device. Each of the learning data can include a data type that is part of a feature space.

The steps can also include processing the machine learning model to derive a scoring vector for the machine learning model. The scoring vector can include a series of elements specifying a relevance of each data type for training the machine learning model. In some instances, each of the elements in the scoring vector provides a value ranking the relevance of each data type for the machine learning model using data specific to the machine learning model.

The steps can also include deriving a similarity matrix from the learning data and the scoring vector. The similarity matrix can include a plurality of cells indicative of a similarity between data of different data types and the series of elements in the scoring vector. In some instances, the plurality of cells in the similarity matrix can include a value specifying a commonality between data instances in the learning data.

The steps can also include generating a list of selected data of the learning data to be stored at the edge device based at least on the similarity matrix. In some instances, the list of selected data is generated based on at least one constraint to the edge device, the at least one constraint comprising any of: a specified data storage capacity of the edge device, a specified processing power of the edge device, a specified bandwidth of the edge device, and a specified power consumption of the edge device.

The steps can also include storing a subset of the learning data according to the list of selected data. The steps can also include further training the machine learning model using the subset of the learning data stored at the edge device.

### Computing System Overview

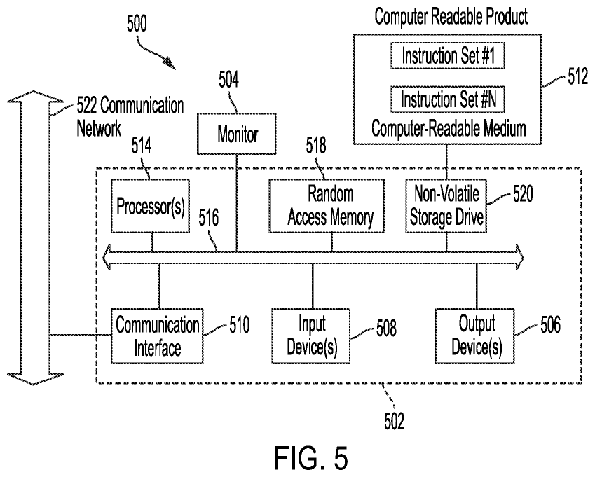

FIG. 5 is a block diagram of a special-purpose computer system 500 according to an embodiment. The methods and processes described herein may similarly be implemented by tangible, non-transitory computer readable storage mediums and/or computer-program products that direct a computer system to perform the actions of the methods and processes described herein. Each such computer-program product may comprise sets of instructions (e.g., codes) embodied on a computer-readable medium that directs the processor of a computer system to perform corresponding operations. The instructions may be configured to run in sequential order, or in parallel (such as under different processing threads), or in a combination thereof.

Special-purpose computer system 500 comprises a computer 502, a monitor 504 coupled to computer 502, one or more additional user output devices 506 (optional) coupled to computer 502, one or more user input devices 508 (e.g., keyboard, mouse, track ball, touch screen) coupled to computer 502, an optional communications interface 510 coupled to computer 502, and a computer-program product including a tangible computer-readable storage medium 512 in or accessible to computer 502. Instructions stored on computer-readable storage medium 512 may direct system 500 to perform the methods and processes described herein. Computer 502 may include one or more processors 514 that communicate with a number of peripheral devices via a bus subsystem 516. These peripheral devices may include user output device(s) 506, user input device(s) 508, communications interface 510, and a storage subsystem, such as random-access memory (RAM) 518 and non-volatile storage drive 520 (e.g., disk drive, optical drive, solid state drive), which are forms of tangible computer-readable memory.

Computer-readable medium 512 may be loaded into random access memory 518, stored in non-volatile storage drive 520, or otherwise accessible to one or more components of computer 502. Each processor 514 may comprise a microprocessor, such as a microprocessor from Intel® or Advanced Micro Devices, Inc.®, or the like. To support computer-readable medium 512, the computer 502 runs an operating system that handles the communications between computer-readable medium 512 and the above-noted components, as well as the communications between the above-noted components in support of the computer-readable medium 512. Exemplary operating systems include Windows® or the like from Microsoft Corporation, Solaris® from Sun Microsystems, LINUX, UNIX, and the like. In many embodiments and as described herein, the computer-program product may be an apparatus (e.g., a hard drive including case, read/write head, etc., a computer disc including case, a memory card including connector, case, etc.) that includes a computer-readable medium (e.g., a disk, a memory chip, etc.). In other embodiments, a computer-program product may comprise the instruction sets, or code modules, themselves, and be embodied on a computer-readable medium.

User input devices 508 include all possible types of devices and mechanisms to input information to computer system 502. These may include a keyboard, a keypad, a mouse, a scanner, a digital drawing pad, a touch screen incorporated into the display, audio input devices such as voice recognition systems, microphones, and other types of input devices. In various embodiments, user input devices 508 are typically embodied as a computer mouse, a trackball, a track pad, a joystick, wireless remote, a drawing tablet, a voice command system. User input devices 508 typically allow a user to select objects, icons, text and the like that appear on the monitor 504 via a command such as a click of a button or the like. User output devices 506 include all possible types of devices and mechanisms to output information from computer 502. These may include a display (e.g., monitor 504), printers, non-visual displays such as audio output devices, etc.

Communications interface 510 provides an interface to other communication networks and devices and may serve as an interface to receive data from and transmit data to other systems, WANs and/or the Internet, via a wired or wireless communication network 522. In addition, communications interface 510 can include an underwater radio for transmitting and receiving data in an underwater network. Embodiments of communications interface 510 typically include an Ethernet card, a modem (telephone, satellite, cable, ISDN), a (asynchronous) digital subscriber line (DSL) unit, a FireWire® interface, a USB® interface, a wireless network adapter, and the like. For example, communications interface 510 may be coupled to a computer network, to a Fire Wire® bus, or the like. In other embodiments, communications interface 510 may be physically integrated on the motherboard of computer 502, and/or may be a software program, or the like.

RAM 518 and non-volatile storage drive 520 are examples of tangible computer-readable media configured to store data such as computer-program product embodiments of the present invention, including executable computer code, human-readable code, or the like. Other types of tangible computer-readable media include floppy disks, removable hard disks, optical storage media such as CD-ROMs, DVDs, bar codes, semiconductor memories such as flash memories, read-only-memories (ROMs), battery-backed volatile memories, networked storage devices, and the like. RAM 518 and non-volatile storage drive 520 may be configured to store the basic programming and data constructs that provide the functionality of various embodiments of the present invention, as described above.

Software instruction sets that provide the functionality of the present invention may be stored in computer-readable medium 512, RAM 518, and/or non-volatile storage drive 520. These instruction sets or code may be executed by the processor(s) 514. Computer-readable medium 512, RAM 518, and/or non-volatile storage drive 520 may also provide a repository to store data and data structures used in accordance with the present invention. RAM 518 and non-volatile storage drive 520 may include a number of memories including a main random-access memory (RAM) to store instructions and data during program execution and a read-only memory (ROM) in which fixed instructions are stored. RAM 518 and non-volatile storage drive 520 may include a file storage subsystem providing persistent (non-volatile) storage of program and/or data files. RAM 518 and non-volatile storage drive 520 may also include removable storage systems, such as removable flash memory.

Bus subsystem 516 provides a mechanism to allow the various components and subsystems of computer 502 communicate with each other as intended. Although bus subsystem 516 is shown schematically as a single bus, alternative embodiments of the bus subsystem may utilize multiple busses or communication paths within the computer 502.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine-readable mediums for storing information. The term “machine-readable medium” includes but is not limited to portable or fixed storage devices, optical storage devices, wireless channels, and/or various other storage mediums capable of storing that contain or carry instruction(s) and/or data.

### CONCLUSION

Whereas many alterations and modifications of the present invention will no doubt become apparent to a person of ordinary skill in the art after having read the foregoing description, it is to be understood that the particular embodiments shown and described by way of illustration are in no way intended to be considered limiting.

Moreover, the processes described above, as well as any other aspects of the disclosure, may each be implemented by software, but may also be implemented in hardware, firmware, or any combination of software, hardware, and firmware. Instructions for performing these processes may also be embodied as machine- or computer-readable code recorded on a machine- or computer-readable medium. In some embodiments, the computer-readable medium may be a non-transitory computer-readable medium. Examples of such a non-transitory computer-readable medium include but are not limited to a read-only memory, a random-access memory, a flash memory, a CD-ROM, a DVD, a magnetic tape, a removable memory card, and optical data storage devices. In other embodiments, the computer-readable medium may be a transitory computer-readable medium. In such embodiments, the transitory computer-readable medium can be distributed over network-coupled computer systems so that the computer-readable code is stored and executed in a distributed fashion. For example, such a transitory computer-readable medium may be communicated from one electronic device to another electronic device using any suitable communications protocol. Such a transitory computer-readable medium may embody computer-readable code, instructions, data structures, program modules, or other data in a modulated data signal, such as a carrier wave or other transport mechanism, and may include any information delivery media. A modulated data signal may be a signal that has one or more of its characteristics set or changed in such a manner as to encode information in the signal.

It is to be understood that any or each module of any one or more of any system, device, or server may be provided as a software construct, firmware construct, one or more hardware components, or a combination thereof, and may be described in the general context of computer-executable instructions, such as program modules, that may be executed by one or more computers or other devices. Generally, a program module may include one or more routines, programs, objects, components, and/or data structures that may perform one or more particular tasks or that may implement one or more particular abstract data types. It is also to be understood that the number, configuration, functionality, and interconnection of the modules of any one or more of any system, device, or server are merely illustrative, and that the number, configuration, functionality, and interconnection of existing modules may be modified or omitted, additional modules may be added, and the interconnection of certain modules may be altered.

While there have been described systems, methods, and computer-readable media for enabling efficient control of a media application at a media electronic device by a user electronic device, it is to be understood that many changes may be made therein without departing from the spirit and scope of the disclosure. Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

Therefore, those skilled in the art will appreciate that the invention can be practiced by other than the described embodiments, which are presented for purposes of illustration rather than of limitation.

What is claimed is:

1. A method for selecting data to be stored at an edge device, the method comprising:
training a machine learning model at the edge device using learning data obtained at the edge device, each of the learning data comprising a data type that is part of a feature space;
processing the machine learning model to derive a scoring vector for the machine learning model, the scoring vector comprising a series of elements specifying a relevance of each data type for training the machine learning model;
deriving a similarity matrix from the learning data and the scoring vector, the similarity matrix comprising a plurality of cells indicative of a similarity between data of different data types and the series of elements in the scoring vector; and
generating a list of selected data of the learning data to be stored at the edge device based at least on the similarity matrix.

2. The method of claim 1, wherein the edge device is part of a cloud computing infrastructure configured to implement the machine learning model at the edge device.

3. The method of claim 1, wherein the learning data comprises input data obtained from one or more sensors connected to the edge device.

4. The method of claim 1, wherein each of the elements in the scoring vector provides a value ranking the relevance of each data type for the machine learning model using data specific to the machine learning model.

5. The method of claim 1, wherein the scoring vector is derived using a feature importance model.

6. The method of claim 1, wherein the plurality of cells in the similarity matrix include a value specifying a commonality between data instances in the learning data.

7. The method of claim 1, wherein the similarity matrix is derived using a gaussian kernel function.

8. The method of claim 1, wherein the list of selected data is generated based on at least one constraint to the edge device, the at least one constraint comprising any of: a specified data storage capacity of the edge device, a specified processing power of the edge device, a specified bandwidth of the edge device, and a specified power consumption of the edge device.

9. The method of claim 1, wherein the list of selected data is generated using a maximize variance model.

10. The method of claim 1, further comprising:
further training the machine learning model using data stored at the edge device according to the list of selected data.

11. A system comprising:
one or more computing nodes;
one or more sensors; and
an edge device in electrical communication with the one or more computing nodes and the one or more sensors, where the edge device is operative to:
obtain a machine learning model from the one or more cloud computing nodes;
obtain learning data from the one or more sensors;
train the machine learning model at the edge device using learning data obtained at the edge device;
process the machine learning model to derive a scoring vector for the machine learning model;
derive a similarity matrix from the learning data and the scoring vector, the similarity matrix comprising a plurality of cells indicative of a similarity between data of different data types and a series of elements in the scoring vector; and
generate a list of selected data of the learning data to be stored at the edge device based at least on the similarity matrix.

12. The system of claim 11, wherein the scoring vector comprising a series of elements specifying a relevance of each data type for training the machine learning model, and wherein each of the similarity of elements in the scoring vector provides a value ranking the relevance of each data type for the machine learning model using data specific to the machine learning model.

13. The system of claim 11, wherein the scoring vector is derived using a feature importance model.

14. The system of claim 11, wherein the plurality of cells in the similarity matrix include a value specifying a commonality between data instances in the learning data.

15. The system of claim 11, wherein the list of selected data is generated based on at least one constraint to the edge device, the at least one constraint comprising any of: a specified data storage capacity of the edge device, a specified processing power of the edge device, a specified bandwidth of the edge device, and a specified power consumption of the edge device.

16. The system of claim 11, wherein the edge device is further operative to:
further train the machine learning model using data stored at the edge device according to the list of selected data.

17. A computer-readable storage medium containing program instructions for a method being executed by an application, the application comprising code for one or more components that are called by the application during runtime, wherein execution of the program instructions by one or more processors of a computer system causes the one or more processors to perform steps comprising:
training a machine learning model at an edge device using learning data obtained at the edge device, each of the learning data comprising a data type that is part of a feature space;
processing the machine learning model to derive a scoring vector for the machine learning model, the scoring vector comprising a series of elements specifying a relevance of each data type for training the machine learning model;
deriving a similarity matrix from the learning data and the scoring vector, the similarity matrix comprising a plurality of cells indicative of a similarity between data of different data types and the series of elements in the scoring vector;
generating a list of selected data of the learning data to be stored at the edge device based at least on the similarity matrix;
storing a subset of the learning data according to the list of selected data; and
further training the machine learning model using the subset of the learning data stored at the edge device.

18. The computer-readable storage medium of claim 17, wherein each of the elements in the scoring vector provides a value ranking the relevance of each data type for the machine learning model using data specific to the machine learning model.

19. The computer-readable storage medium of claim 17, wherein the plurality of cells in the similarity matrix include a value specifying a commonality between data instances in the learning data.

20. The computer-readable storage medium of claim 17, wherein the list of selected data is generated based on at least one constraint to the edge device, the at least one constraint comprising any of: a specified data storage capacity of the edge device, a specified processing power of the edge device, a specified bandwidth of the edge device, and a specified power consumption of the edge device.
